(19) United States
(12) Patent Application Publication
(10) Pub. No.: US 2014/0136796 A1
(43) Pub. Date: May 15, 2014

(54) ARITHMETIC PROCESSING DEVICE AND METHOD FOR CONTROLLING THE SAME

(71) Applicant: FUJITSU LIMITED, Kawasaki-shi (JP)

(72) Inventor: Takashi MIURA, Kawasaki (JP)

(73) Assignee: FUJITSU LIMITED, Kawasaki-shi (JP)

(21) Appl. No.: 14/075,211

(22) Filed: Nov. 8, 2013

(30) Foreign Application Priority Data
Nov. 12, 2012 (JP) 2012-248661
Oct. 23, 2013 (JP) 2013-220675

(51) Int. Cl. G06F 12/08

(52) U.S. Cl. CPC G06F 12/0855
USPC 711/140

(57) ABSTRACT

An arithmetic processing device includes a cache memory, a first controller configured to control the cache memory and a second controller assigned a non-cache space to be accessed without use of the cache memory, wherein, when a condition, that out-of-order processing of a first and a second access requests for the non-cache space is possible and access targets of the first and second access requests are the same, is satisfied, the first controller issues the second access request to the second controller without waiting for a completion notification from the second controller with respect to the first access request previously issued to the second controller, and when the condition is not satisfied, the first controller issues the second access request to the second controller after waiting for a completion notification from the second controller with respect to first access request previously issued to the second controller.

### CROSS-REFERENCE TO RELATED APPLICATIONS

This application is based upon and claims the benefit of priority from the prior Japanese Patent Application No. 2012-248661 filed on Nov. 12, 2012 and No. 2013-220675 filed on Oct. 23, 2013, the entire contents of which are incorporated herein by reference.

### FIELD

The embodiment discussed herein is related to an arithmetic processing device and a method for controlling the arithmetic processing device.

### BACKGROUND

Central processing units (CPUs) have access instructions for non-cache space as commands. The term “non-cache space” refers to a memory space accessed without use of a cache memory. The access instructions for the non-cache space are instructions for accessing, without use of a cache memory, a memory space allocated to a device to be accessed. Accessing the non-cache space by using a non-cache instruction is defined as reading from and/or writing to an address space defined as a non-cacheable space.

Operation for accessing the non-cache space involves reading from or writing to a register or giving an instruction for operation on an input/output (I/O) device. For example, with a non-cache request for a memory controller, it is possible to access a register included in the memory controller. For example, with a non-cache request for a Peripheral Component Interconnect Express (PCIe) controller, it is possible to access a register in the PCIe controller or a register in an external device, such as a PCIe card. In addition, for example, with a non-cache request for a CPU interface controller, it is possible to access a device, such as a memory controller or a PCIe controller, coupled to another CPU.

Interrupt processing from a driver of a device often involves an access pattern that a non-cache write operation is executed on the device multiple times and then a non-cache read operation is executed once for synchronization. Accordingly, it is desirable to make it possible to efficiently issue non-cache requests in sequence.

According to typical non-cache control, a primary cache controller uses, upon receiving a request issued from an instruction controller, a translation lookaside buffer (TLB) to translate an access-target virtual address into a physical address. When an NC bit in the physical address (that is, a bit indicating whether the physical address is a cacheable space or a non-cacheable space) indicates a non-cacheable space, the primary cache controller issues a non-cache request to a secondary cache controller. The secondary cache controller issues the non-cache request to a system controller (such as a memory controller, a PCIe controller, or a CPU interface controller) at the request destination.

When a next request issued from the instruction controller is a non-cache request, this request waits at the primary cache controller. When the system controller completes processing for the initial request, the system controller issues a completion notification to the secondary cache controller. The secondary cache controller receives the completion notification and then sends the completion notification to the primary cache controller. Upon receiving the completion notification, the primary cache controller is allowed to issue the next non-cache request that has been waiting to the secondary cache controller.

As described above, in the related art, a CPU core having a primary cache controller therein is not permitted to issue a next non-cache request to a secondary cache controller without waiting for a completion notification from a device to which a previous non-cache request has been issued. However, if a system in which a device completion notification from the CPU core is waited for in any case is employed even when there are cases in which non-cache requests can be sequentially issued without waiting for the device completion notification, the efficiency of the processing of the non-cache request decreases.

An example of the related art is disclosed in Japanese Laid-open Patent Publication No. 2007-172609.

In view of the foregoing, it is desirable to provide an arithmetic processing device that is capable of efficiently issuing non-cache requests.

### SUMMARY

According to an aspect of the embodiment, an apparatus includes a cache memory, a first controller configured to control the cache memory and a second controller assigned a non-cache space to be accessed without use of the cache memory, wherein, when a condition that out-of-order processing of first and second access requests for the non-cache space is possible and access targets of the first and second access requests are the same is satisfied, the first controller issues the second access request to the second controller without waiting for a completion notification from the second controller with respect to the first access request previously issued to the second controller, and when the condition is not satisfied, the first controller issues the second access request to the second controller after waiting for a completion notification from the second controller with respect to first access request previously issued to the second controller.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of the configuration of an arithmetic processing system including an arithmetic processing device, peripheral devices, and so on;

FIG. 2 illustrates an example of the format of an access request issued from an instruction controller;

FIG. 3 illustrates an example of the format of an access request issued from a primary cache controller;

FIGS. 4A and 4B are flowcharts illustrating a flow of access-request issuance processing;

FIG. 5 illustrates an example of an operation of access-request issuance processing;

FIG. 6 illustrates another example of the operation of the access-request issuance processing; and

FIG. 7 illustrates yet another example of the operation of the access-request issuance processing.

FIG. 8 illustrates the format of a field TTE in a TLB; and

FIG. 9 illustrates a circuit configuration for the access-request issuance processing.

### DESCRIPTION OF EMBODIMENT

An embodiment of the present disclosure is described below in detail with reference to the accompanying drawings.

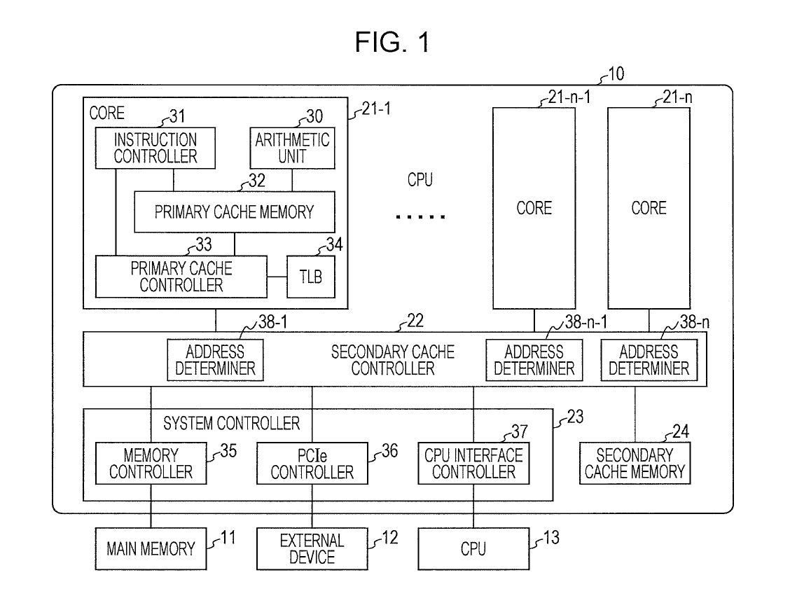

FIG. 1 is a block diagram illustrating an example of the configuration of an arithmetic processing system including an arithmetic processing device, peripheral devices, and so on. The arithmetic processing system illustrated in FIG. 1 includes a CPU 10, a main memory 11, an external device 12, and another CPU 13. The CPU 10 serves as an arithmetic processing device. The CPU 10 includes CPU cores 21-1 to 21-n, a secondary cache controller 22, a system controller 23, and a secondary cache memory 24. The CPU cores 21-1 to 21-n have substantially the same configuration. As represented by the CPU core 21-1, each of the CPU cores 21-1 to 21-n includes an arithmetic unit 30, an instruction controller 31, a primary cache memory 32, a primary cache controller 33, and a TLB 34. The secondary cache controller 22 includes address identifiers 38-1 to 38-n corresponding to the respective CPU cores 21-1 to 21-n. The system controller 23 includes a memory controller 35, a PCIe controller 36, and a CPU interface controller 37.

In FIG. 1, boundaries between the functional blocks and other functional blocks, which are represented by the boxes, basically indicate functional boundaries, and may or may not correspond to separation of physical positions, separation of electrical signals, control and logical separation, and so on. Each functional block may indicate a single hardware module physically separated from another functional block to some extent or may indicate one function of a hardware module into which the functional block and another functional block are physically integrated together.

The CPU cores 21-1 to 21-n share the secondary cache memory 24 and access the secondary cache memory 24 via the secondary cache controller 22. The CPU cores 21-1 to 21-n also access the memory controller 35, the PCIe controller 36, and the CPU interface controller 37, included in the system controller 23, via the secondary cache controller 22. The memory controller 35 controls the main memory 11, which is an external memory. The PCIe controller 36 controls the external device 12, such as a PCIe card. The CPU interface controller 37 controls exchange of information with the CPU 13, which has a configuration and functions that are the same as or similar to those of the CPU 10. The memory controller 35, the PCIe controller 36, and the CPU interface controller 37, included in the system controller 23, are allocated non-cache spaces accessed without use of the primary and secondary cache memories 32 and 24.

The instruction controller 31 decodes an instruction fetched from the primary cache memory 32. In accordance with a result of the decoding, the instruction controller 31 controls execution of an arithmetic instruction issued from the arithmetic unit 30. The instruction controller 31 also issues an access request (an instruction unit request (IU-REQ)), such as a load instruction or a store instruction, to the primary cache controller 33 to execute processing, such as data loading or data storage, on the primary cache memory 32.

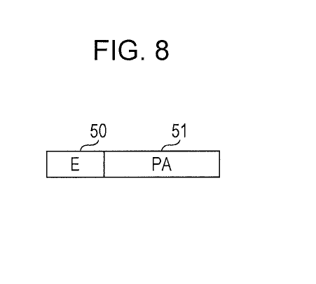

Upon receiving the access request IU-REQ issued from the instruction controller 31, the primary cache controller 33 refers to the TLB 34 to translate a virtual address in the access request into a physical address. As illustrated in FIG. 8, the TLB 34 contains translation table entries (TTEs), each having an E bit 50 (a field TTEe) indicating whether or not there is a side effect in a corresponding access space and a PA 51 indicating a physical page number. When an access-target address in the access request corresponds to a memory space in a device that performs in-order processing, TTEe=1 is obtained upon reference to the TLB 34. When an access-target address in the access request corresponds to a memory space in a device that is capable of performing out-of-order processing of access requests, TTEe=0 is obtained upon reference to the TLB 34.

A physical address obtained from the virtual address and the PA 51 by referring to the TLB 34 includes an NC bit indicating whether the physical address is a cacheable space or a non-cacheable space. When the NC bit indicates a non-cacheable space, the primary cache controller 33 issues a non-cache request NC-REQ to the secondary cache controller 22. When the NC bit indicates a cacheable space, the primary cache controller 33 executes access to the primary cache memory 32. The primary cache memory 32 and the secondary cache memory 24 have a hierarchical structure. Thus, when the access does not “hit” in the primary cache memory 32, access to the secondary cache memory 24 is executed via the secondary cache controller 22. The primary cache controller 33 and the secondary cache controller 22 control the cache memories (that is, the primary cache memory 32 and the secondary cache memory 24).

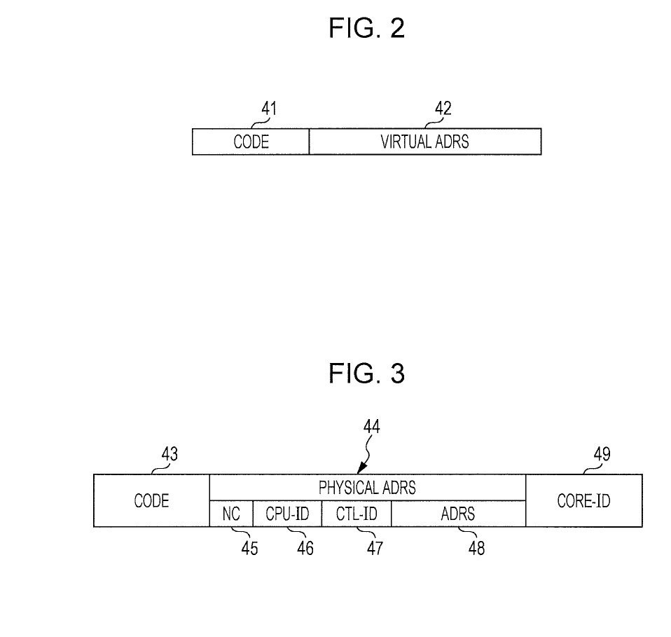

FIG. 2 illustrates an example of the format of the access request IU-REQ. As illustrated in FIG. 2, the access request IU-REQ, which is issued from the instruction controller 31 to the primary cache controller 33, includes an instruction code (opcode) 41 and a virtual address 42. The instruction code 41 indicates the type of a corresponding instruction. For example, the instruction code 41 indicates that a corresponding instruction is, for example, a store instruction (write instruction) or a load instruction (read instruction). The virtual address 42 indicates a target accessed by a store instruction, a load instruction, or the like.

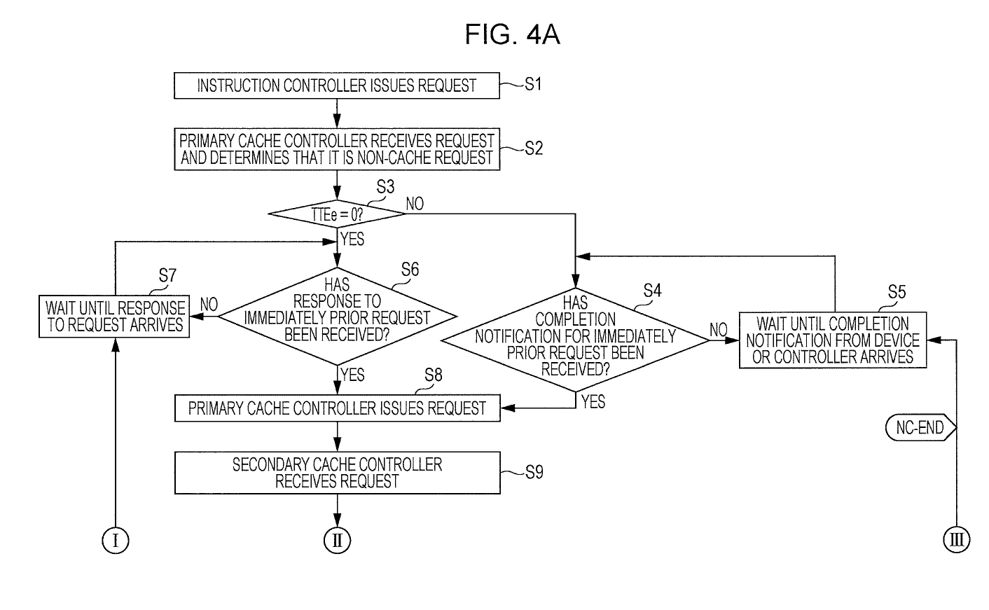

FIG. 3 illustrates an example of the format of the access request NC-REQ. As illustrated in FIG. 3, the access request NC-REQ, which is issued from the primary cache controller 33 to the secondary cache controller 22, includes a non-cache instruction code (opcode) 43 and a physical address 44, and a core-ID 49. The non-cache instruction code 43 indicates the type of a corresponding instruction. For example, the non-cache instruction code 43 indicates that a corresponding instruction is, for example, a non-cache store instruction (write instruction) or a non-cache load instruction (read instruction). The physical address 44 includes an NC bit 45, a CPU-ID 46 serving as a CPU identifier, a CTL-ID 47 serving as controller identifier, and an address 48. The core-ID 49 indicates a CPU core identifier.

As described above, the NC bit 45 indicates whether an access-target address (that is, a target specified by the address 48) is a cacheable space or a non-cacheable space. The CPU-ID 46 is an identifier for identifying the CPU 10 or 13 to be accessed by the access request NC-REQ. For example, when the access request NC-REQ accesses the PCIe controller 36 in the CPU 10 illustrated in FIG. 1, the CPU-ID 46 serves as an identifier for identifying the CPU 10 illustrated in FIG. 1. When the access request NC-REQ accesses a PCIe controller in the CPU 13 illustrated in FIG. 1, the CPU-ID 46 serves as an identifier for identifying the CPU 13 illustrated in FIG. 1. The CTL-ID 47 is an identifier for identifying the memory controller 35, the PCIe controller 36, or the CPU interface controller 37 to be accessed. For example, when the access request NC-REQ accesses the PCIe controller 36 in the CPU 10 illustrated in FIG. 1, the CTL-ID 47 serves as an identifier for identifying the PCIe controller 36. The address 48 is an access-target physical address in the memory space. For example, when the access request NC-REQ accesses the PCIe controller 36 in the CPU 10 illustrated in FIG. 1, the address 48 indicates a specific address in the memory space allocated to the PCIe controller 36. The core-ID 49 is created from an access request NC-REQ from the corresponding CPU core 21-1, . . . , or 21-n and serves as an identifier for identifying the CPU core 21-1, . . . , or 21-n that is the request source of the access request NC-REQ.

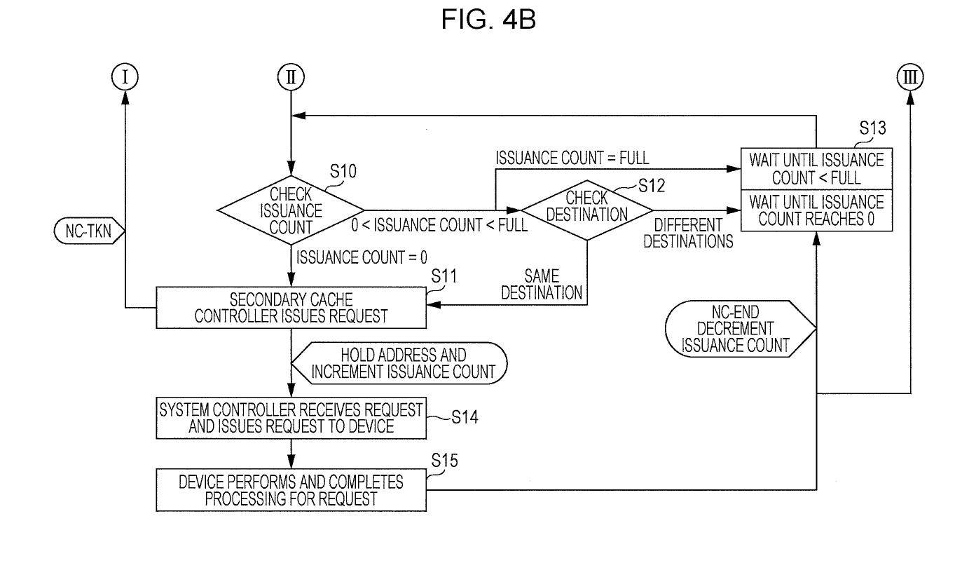

FIGS. 4A and 4B are flowcharts illustrating a flow of access-request issuance processing. Access-request issuance processing is described with reference to FIGS. 4A and 4B.

In operation S1 in FIG. 4A, the instruction controller 31 issues an access request IU-REQ. In operation S2, the primary cache controller 33 first receives the access request IU-REQ. On the basis of the virtual address in the access request, the primary cache controller 33 refers to the TLB 34 to obtain a physical address corresponding to the virtual address. The primary cache controller 33 further checks the NC bit in the physical address to determine whether or not the access request is to access a non-cache space. When the access request is to access a cache space, general cache-access control is executed on the primary cache memory 32 and/or the secondary cache memory 24. When the access request is to access a non-cache space, processing in operation S3 and the subsequent operations is executed.

In operation S3, the primary cache controller 33 determines whether or not the value of the field TTEe obtained by referring to the TLB 34 is 0. When the field TTEe does not indicate 0 (that is, TTEe=1), this means that the access-target memory space is on a device that performs in-order processing. In this case, in operation S4, the primary cache controller 33 determines whether or not a completion notification (that is, a notification indicating that execution of requested processing is completed) with respect to a request immediately prior to that access request has already been received from the device to be accessed or the system controller 23. When the completion notification has already been received, the primary cache controller 33 issues an access request NC-REQ to the secondary cache controller 22 (in operation S8). When the completion notification has not been received, the primary cache controller 33 waits in operation S5 until the completion notification from the device to be accessed or the system controller 23 arrives. When the completion notification arrives, the primary cache controller 33 issues an access request NC-REQ to the secondary cache controller 22 (in operation S8).

Thus, upon determining that out-of-order processing of access requests for the non-cache space is not possible, the primary cache controller 33 waits for a completion notification with respect to an access request previously issued to the secondary cache controller 22. The completion notification arrives via the system controller 23 from the device to be accessed or arrives from the system controller 23. After waiting for the completion notification with respect to the previously issued access request (that is, when the completion notification arrives), the primary cache controller 33 issues the access request currently being processed to the secondary cache controller 22.

When the result of the determination in operation S3 indicates TTEe=0, this means that the access-target memory space corresponds to a device that is capable of performing out-of-order processing of access requests. In this case, in operation S6, the primary cache controller 33 checks whether or not a response NC-TKN from the secondary cache controller 22 with respect to an immediately prior request has been received. This response NC-TKN is a response that the secondary cache controller 22, when an access request is issued to the system controller 23, sends to the primary cache controller 33 without waiting for the above-described completion notification.

When the response NC-TKN has not been received (NO in operation S6), the process proceeds to operation S7 in which the primary cache controller 33 waits until the response NC-TKN arrives. Upon receiving the response NC-TKN (YES in operation S6), the primary cache controller 33 issues an access request NC-REQ to the secondary cache controller 22 in operation S8.

Thus, upon determining that out-of-order processing of access requests for the non-cache space is possible, the primary cache controller 33 waits for a response to an access request previously issued to the secondary cache controller 22. The response in this case is a response that the secondary cache controller 22, when an access request is issued to the system controller 23, sends to the primary cache controller 33 without waiting for a completion notification. After waiting for the response to the previously issued access request (that is, when the response arrives), the primary cache controller 33 issues the access request currently being processed to the secondary cache controller 22.

In operation S9, the secondary cache controller 22 receives the access request from the primary cache controller 33. In operation S10 in FIG. 4B, the secondary cache controller 22 checks an issuance count of requests to the system controller 23. In this case, the issuance count of requests is the number of, out of requests that have been issued from the secondary cache controller 22 to the system controller 23, requests for which corresponding completion notifications have not arrived from the system controller 23.

When the result of the determination in operation S10 indicates that the issuance count is 0, the process proceeds to operation S11 in which the secondary cache controller 22 issues an access request to the system controller 23 and also sends a response NC-TKN to the primary cache controller 33. The secondary cache controller 22 further holds (stores) the address in the issued access request and increments the issuance count by 1.

When the result of the determination in operation S10 indicates that the issuance count is larger than 0 and less than “full”, the process proceeds to operation S12 in which the secondary cache controller 22 compares a stored address of the immediately prior access request with the address in the access request currently being processed. This comparison is performed in order to check an access target (“destination”).

When the condition that the access targets of two access requests (that is, the immediately preceding and current access requests) are the same is satisfied, (that is, “same destination” in operation S12), the process proceeds to operation S11 in which the secondary cache controller 22 issues an access request to the system controller 23. In this case, the secondary cache controller 22 issues the access request currently being processed to the system controller 23, without waiting for the completion notification from the system controller 23 with respect to the access request previously issued to the system controller 23. As described above, the system controller 23 includes multiple controllers (that is, the memory controller 35, the PCIe controller 36, and the CPU interface controller 37). Thus, for issuing an access request to the system controller 23, the secondary cache controller 22 issues the access request to, of the memory controller 35, the PCIe controller 36, and the CPU interface controller 37, one controller indicated by the CTL-ID 47 in the physical address (see FIG. 3) in the access request NC-REQ. When two access requests access the same one of the memory controller 35, the PCIe controller 36, and the CPU interface controller 37, the secondary cache controller 22 determines that the access targets of the two access requests are the same. More specifically, when the NC bits 45, the CPU-IDs 46, and the CTL-IDs 47 located at the top-bit sides in the physical addresses 44 (illustrated in FIG. 3) in two access requests match each other, the secondary cache controller 22 determines that the access targets of the two access requests are the same. Even when the addresses 48 at the bottom-bit sides in two access requests are different from each other, the secondary cache controller 22 determines that the access targets of the two access requests are the same.

When the condition that the access targets of two (that is, immediately preceding and current) access requests are the same is not satisfied (that is, “different destinations” in operation S12), the process proceeds to operation S13 in which the secondary cache controller 22 waits until the issuance count reaches 0. The issuance count is decremented by 1, each time a completion notification (that is, a completion notification NC-END indicating that execution of requested processing is completed) from the system controller 23 with respect to an access request already issued to the system controller 23 arrives. When the issuance count reaches 0, the secondary cache controller 22 issues the access request currently being processed to the system controller 23 (in operation S11). Thus, when the condition that the access targets are the same is not satisfied, the secondary cache controller 22 waits for a completion notification from the system controller 23 with respect to an access request previously issued to the system controller 23. After waiting for the completion notification from the system controller 23 with respect to the previously issued access request, the secondary cache controller 22 issues the access request currently being processed to the system controller 23. When the number of access requests previously issued to the system controller 23 is plural, the secondary cache controller 22 issues the access request currently being processed to the system controller 23 after waiting for completion notifications from the system controller 23 with respect to all of the access requests.

When the result of the determination in operation S10 indicates that the issuance count is “full”, the process proceeds to operation S13 in which the secondary cache controller 22 waits until the issuance count is less than “full”. In this case, the term “full” refers to the number of requests that the secondary cache controller 22 is able to receive, and depends on, for example, the capacity of a buffer built into the secondary cache controller 22 that holds received requests.

In operation S14, the system controller 23 (the memory controller 35, the PCIe controller 36, or the CPU interface controller 37) receives the access request, and issues a request to the corresponding device, as appropriate. That is, the system controller 23 issues a request to the main memory 11, the external device 12, the CPU 13, or the like. For example, when the PCIe controller 36 receives the request and the received request is to access the register in the PCIe controller 36, the system controller 23 does not issue a request to the external device 12. On the other hand, when the received request is to access the external device 12, the PCIe controller 36 issues a request to the external device 12.

When the device or the system controller 23 performs processing for the request and completes the processing in operation S15, the system controller 23 sends a completion notification NC-END indicating that the processing is completed to the secondary cache controller 22. As described above, each time a completion notification NC-END arrives, the secondary cache controller 22 performs processing for decrementing the issuance count by 1.

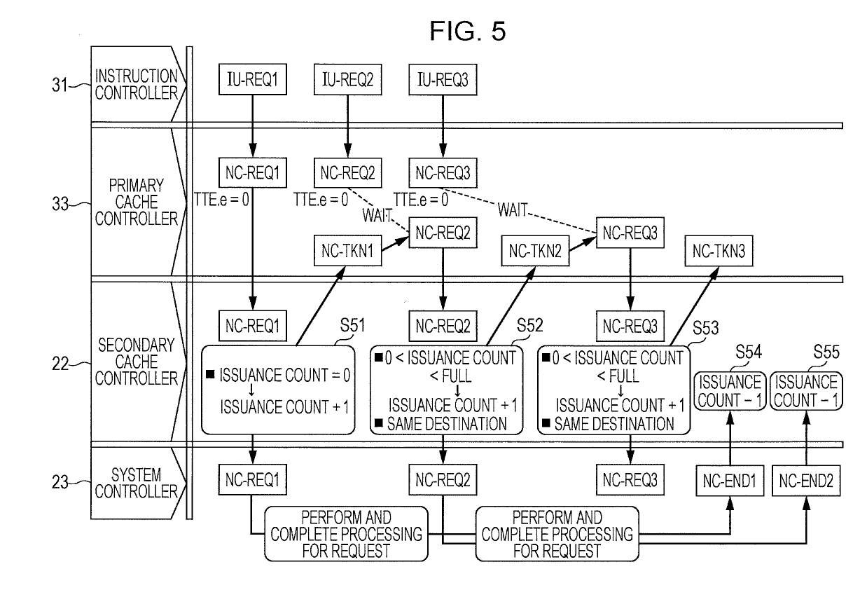

FIG. 5 illustrates an example of an operation of access-request issuance processing. First, the instruction controller 31 issues a request IU-REQ1 to the primary cache controller 33. When the field TTEe corresponding to the request IU-REQ1 indicates 0, the primary cache controller 33 issues a non-cache request NC-REQ1 to the secondary cache controller 22. In this case, when the instruction controller 31 issues next requests IU-REQ2 and IU-REQ3 and the corresponding fields TTEe indicate 0, corresponding non-cache requests NC-REQ2 and NC-REQ3 wait at the primary cache controller 33.

Upon receiving the non-cache request NC-REQ1 from the primary cache controller 33, the secondary cache controller 22 immediately issues the non-cache request NC-REQ1 to the system controller 23, since the issuance count in the initial state is 0. In this case, the issuance count is incremented by 1 (in operation S51). Simultaneously with, in parallel with, immediately before, or immediately after the issuance of the non-cache request NC-REQ1, the secondary cache controller 22 issues a response NC-TKN1 to the primary cache controller 33 as a notification indicating the issuance of the non-cache request NC-REQ1. Upon receiving the response NC-TKN1, the primary cache controller 33 issues the next non-cache request NC-REQ2 to the secondary cache controller 22.

Upon receiving the non-cache request NC-REQ2, the secondary cache controller 22 compares the access target of the non-cache request NC-REQ1 with the access target of the non-cache request NC-REQ2. When the access targets are the same, (that is, the same destination), the secondary cache controller 22 immediately issues the non-cache request NC-REQ2 to the system controller 23. In this case, the issuance count is incremented by 1 (in operation S52). Simultaneously with, in parallel with, immediately before, or immediately after the issuance of the non-cache request NC-REQ2, the secondary cache controller 22 issues a response NC-TKN2 to the primary cache controller 33 as a notification indicating the issuance of the non-cache request NC-REQ2. Upon receiving the response NC-TKN2, the primary cache controller 33 issues the next non-cache request NC-REQ3 to the secondary cache controller 22.

Upon receiving the non-cache request NC-REQ3, the secondary cache controller 22 compares the access target of the non-cache request NC-REQ2 with the access target of the non-cache request NC-REQ3. When the access targets are the same (that is, “same destination”), the secondary cache controller 22 immediately issues the non-cache request NC-REQ3 to the system controller 23. In this case, the issuance count is incremented by 1 (in operation S53). Simultaneously with, in parallel with, immediately before, or immediately after the issuance of the non-cache request NC-REQ3, the secondary cache controller 22 issues a response NC-TKN3 to the primary cache controller 33 as a notification indicating the issuance of the non-cache request NC-REQ3.

When request completion notifications NC-END1 and NC-END2 are sent from the system controller 23 to the secondary cache controller 22, the secondary cache controller 22 decrements the issuance counts by 1 for each of the completion notifications NC-END1 and NC-END2 (in operations S54 and S55).

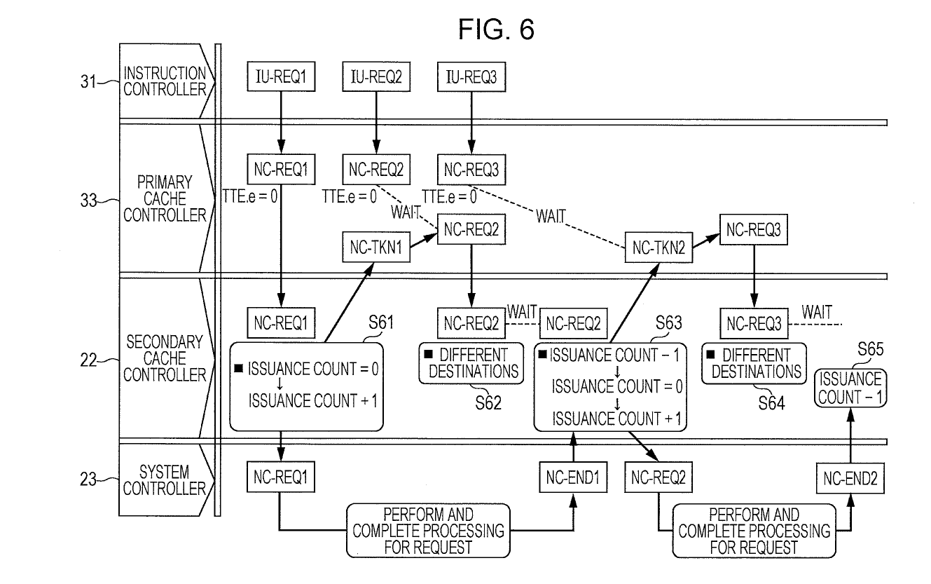

FIG. 6 illustrates another example of the operation of the access-request issuance processing. First, the instruction controller 31 issues a request IU-REQ1 to the primary cache controller 33. When the field TTEe corresponding to the request IU-REQ1 indicates 0, the primary cache controller 33 issues a non-cache request NC-REQ1 to the secondary cache controller 22. In this case, when the instruction controller 31 issues next requests IU-REQ2 and IU-REQ3 and the corresponding fields TTEe indicate 0, corresponding non-cache request NC-REQ2 and NC-REQ3 wait at the primary cache controller 33.

Upon receiving the non-cache request NC-REQ1 from the primary cache controller 33, the secondary cache controller 22 immediately issues the non-cache request NC-REQ1 to the system controller 23, since the issuance count in the initial state is 0. In this case, the issuance count is incremented by 1 (in operation S61). Simultaneously with, in parallel with, immediately before, or immediately after the issuance of the non-cache request NC-REQ1, the secondary cache controller 22 issues a response NC-TKN1 to the primary cache controller 33 as a notification indicating the issuance of the non-cache request NC-REQ1. Upon receiving the response NC-TKN1, the primary cache controller 33 issues the next non-cache request NC-REQ2 to the secondary cache controller 22.

Upon receiving the non-cache request NC-REQ2, the secondary cache controller 22 compares the access target of the non-cache request NC-REQ1 with the access target of the non-cache request NC-REQ2. Since the access targets are different from each other (that is, “different destinations” in operation S62), the secondary cache controller 22 causes the non-cache request NC-REQ2 to wait until a completion notification NC-END1 with respect to the non-cache request NC-REQ1 previously issued to the system controller 23 arrives. When the completion notification NC-END1 with respect to the non-cache request NC-REQ1 arrives from the system controller 23, the secondary cache controller 22 decrements the issuance count by 1 (in operation S63). As a result, since the issuance count reaches 0, the secondary cache controller 22 issues the non-cache request NC-REQ2 to the system controller 23. In response to the issuance, the issuance count is incremented by 1 (in operation S63). Simultaneously with, in parallel with, immediately before, or immediately after the issuance of the non-cache request NC-REQ2, the secondary cache controller 22 issues a response NC-TKN2 to the primary cache controller 33 as a notification indicating the issuance of the non-cache request NC-REQ2. Upon receiving the response NC-TKN2, the primary cache controller 33 issues a next non-cache request NC-REQ3 to the secondary cache controller 22.

Upon receiving the non-cache request NC-REQ3, the secondary cache controller 22 compares the access target of the non-cache request NC-REQ2 with the access target of the non-cache request NC-REQ3. Since the access targets are different from each other (that is, “different destinations” in operation S64), the secondary cache controller 22 causes the non-cache request NC-REQ3 to wait until a completion notification NC-END2 with respect to the non-cache request NC-REQ2 previously issued to the system controller 23 arrives.

When the request completion notification NC-END2 is sent from the system controller 23 to the secondary cache controller 22, the secondary cache controller 22 decrements the issuance count by 1 (in operation S65).

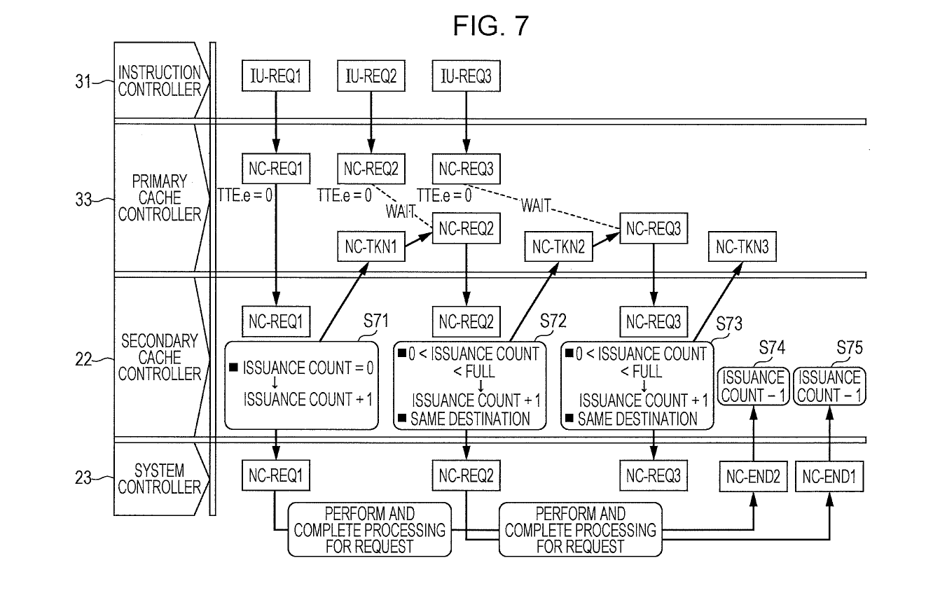

FIG. 7 illustrates yet another example of the operation of the access-request issuance processing. In the example illustrated in FIG. 7, operations of the instruction controller 31, the primary cache controller 33, and the secondary cache controller 22 are substantially the same as those illustrated in FIG. 5. In the example in FIG. 7, unlike the case in FIG. 5, the request processing performed by the system controller 23 or the device is completed on the non-cache request NC-REQ1 earlier than on the non-cache request NC-REQ2. As a result, the system controller 23 issues, to the secondary cache controller 22, a completion notification NC-END2 with respect to the non-cache request NC-REQ2 earlier than a completion notification NC-END1 with respect to the non-cache request NC-REQ1. Since the fields TTEe corresponding to the non-cache requests NC-REQ1 and NC-REQ2 indicate 0, the access-target memory spaces correspond to a device that is capable of out-of-order processing of access requests. Thus, as in the case of the operation example illustrated in FIG. 7, the processing of the non-cache request NC-REQ2 issued later may be executed prior to the processing of the non-cache request NC-REQ1 issued earlier and the completion notification NC-END2 corresponding to the non-cache request NC-REQ2 may be issued earlier. Thus, when out-of-order processing of access requests is possible, the processing of a subsequently issued access request may be started earlier and completed earlier than the processing of a previously issued access request or may be started later and completed earlier than the processing of a previously issued access request. That is, when out-of-order processing of access requests is possible, the order of processing may be different from the order of issuances of the access requests. In addition, the different order of processing from the order of issuances of the access requests does not cause any inconvenience in the result of the processing.

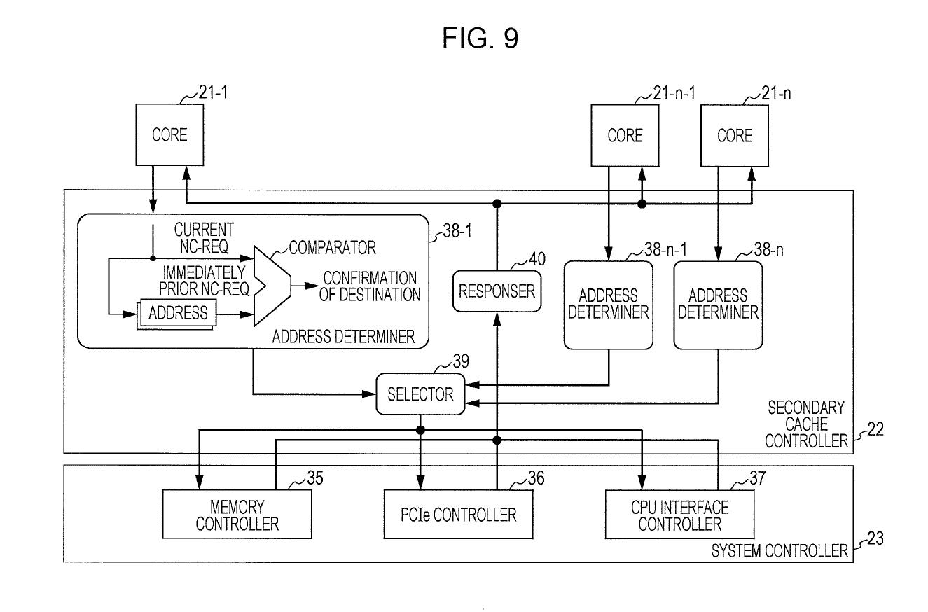

FIG. 9 is a diagram illustrating a circuit configuration for the access-request issuance processing. CPU cores 21-1 to 21-n issue non-cache requests NC-REQ to a secondary cache controller 22. The secondary cache controller 22 has address determiners 38-1 to 38-n corresponding to the respective CPU cores 21-1 to 21-n. Each of the address determiners 38-1 to 38-n confirms the destination of the corresponding non-cache request NC-REQ. Upon receiving a non-cache request NC-REQ from any of the CPU cores 21-1 to 21-n, the corresponding one of the address determiners 38-1 to 38-n holds the address in the non-cache request NC-REQ. In the confirmation of the destination, the CPU-ID 46 and the CTL-ID 47 in the non-cache request NC-REQ currently being processed are compared with those in the immediately prior non-cache request NC-REQ to determine whether or not the destinations thereof are the same. After the non-cache request NC-REQ is issued to a system controller 23, the address in the non-cache request NC-REQ is continuously held. A selector 39 arbitrarily selects an executable one of the non-cache requests NC-REQ received from the CPU cores 21-1 to 21-n and issues the selected non-cache request NC-REQ to the system controller 23. When the secondary cache controller 22 receives a request completion notification NC-END from the system controller 23, a responder 40 in the secondary cache controller 22 checks a core-ID attached to the completion notification NC-END and sends the completion notification NC-END back to, of the CPU cores 21-1 to 21-n, the CPU core that is the issuance source of the non-cache request NC-REQ.

While the present disclosure has been described above in conjunction with the embodiment, the present disclosure is not limited to the embodiment and various modifications and changes may be made thereto without departing from the scope of the appended claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An arithmetic processing device comprising:
a cache memory;
a first controller configured to control the cache memory; and
a second controller assigned a non-cache space to be accessed without use of the cache memory,
wherein, when a condition, that out-of-order processing of a first and a second access requests for the non-cache space is possible and access targets of the first and second access requests are the same, is satisfied, the first controller issues the second access request to the second controller without waiting for a completion notification from the second controller with respect to the first access request previously issued to the second controller, and when the condition is not satisfied, the first controller issues the second access request to the second controller after waiting for a completion notification from the second controller with respect to first access request previously issued to the second controller.

2. The arithmetic processing device according to claim 1,
wherein the second controller comprises a plurality of controllers, and when the first and second access requests access the same one of the plurality of controllers, the first controller determines that the access targets of the first and second access requests are the same.

3. The arithmetic processing device according to claim 1,
wherein the first controller comprises a first cache controller and a second cache controller;
upon determining that out-of-order processing of the first and second access requests for the non-cache space is possible, the first cache controller issues the second access request to the second cache controller after waiting for a response from the second cache controller with respect to the first access request previously issued to the second cache controller, and upon determining that out-of-order processing of the first and second access requests for the non-cache space is not possible, the first cache controller issues the second access request to the second cache controller after waiting for a completion notification from the second controller with respect to the first access request previously issued to the second cache controller; and
when the second cache controller issues the first access request to the second controller, the second cache controller sends the response to the first cache controller without waiting for the completion notification.

4. The arithmetic processing device according to one of claim 1,
wherein, when out-of-order processing of access requests for the non-cache space is possible and the access targets of the access requests are not the same, the first controller issues a next access request to the second controller after waiting for completion notifications from the second controller with respect to all access requests previously issued to the second controller.

5. The arithmetic processing device according to one of claim 1, further comprising a translation lookaside buffer used for translating a logical address into a physical address,
wherein, based on information included in the translation lookaside buffer, the first controller determines whether or not out-of-order processing of the first and second access requests for the non-cache space is possible.

6. A method for controlling an arithmetic processing device including a cache memory, a first controller that controls the cache memory, and a second controller assigned a non-cache space to be accessed without use of the cache memory, the method comprising:
determining whether or not a first condition, that out-of-order processing of a first and a second access requests for the non-cache space is possible, is satisfied;
deterring whether or not a second condition that access targets of the first and the second access requests are the same is satisfied;
causing, when both of the first condition and the second condition are satisfied, the first controller to issue the second access request to the second controller without waiting for a completion notification from the second controller with respect to the first access request previously issued to the second controller; and
causing, when at least one of the first condition and the second condition is not satisfied, the first controller to issue the second access request to the second controller after waiting for a completion notification from the second controller with respect to the first access request previously issued to the second controller.

7. The method according to claim 6,
wherein the second controller comprises a plurality of controllers, and when the first and second access requests access the same one of the plurality of controllers, the first controller determines that the second condition is satisfied.
